(19) United States
(12) Patent Application Publication
(10) Pub. No.: US 2024/0160173 A1
(43) Pub. Date: May 16, 2024

(54) AUTOMATED TRANSPORTATION SYSTEM

(71) Applicant: TOYOTA JIDOSHA KABUSHIKI KAISHA, Toyota-shi, (JP)

(72) Inventors: Yuki TADOKORO, Nagoya-shi (JP); Ellie MATSUNO, Miyoshi- shi (JP)

(73) Assignee: TOYOTA JIDOSHA KABUSHIKI KAISHA, Toyota-shi, (JP)

(21) Appl. No.: 18/485,468

(22) Filed: Oct. 12, 2023

(30) Foreign Application Priority Data
Nov. 16, 2022 (JP) 2022-183161

(51) Int. Cl. G05B 19/042; G06K 7/10; G06K 7/14

(52) U.S. Cl. CPC G05B 19/042; G06K 7/10722; G06K 7/1413; G06K 7/1417; G05B 2219/2621

(57) ABSTRACT

An automated transportation system comprises: an automated transportation device configured to transport an object to be conveyed, a stereo camera configured to obtain an image of the identification code and the stop position confirmation marker, and an information processing device configured to obtain a three-dimensional stop position information of the automated transportation device and the identification information from the taken image. The automated transportation device includes an identification code and a stop position confirmation marker attached to the automated transportation device. The identification code indicates an identification information to identify at least either one of the object to be conveyed and the automated transportation device. The stereo camera is arranged at a predetermined stop position of the automated transportation device. The information processing device transmits the three-dimensional stop position information to a post-process equipment when the identification information is compatible with a predetermined condition.

### CROSS REFERENCE TO RELATED APPLICATIONS

The present application claims priority from Japanese patent application 2022-183161 filed on Nov. 16, 2022, the disclosure of which is hereby incorporated in its entirety by reference into the present application.

### BACKGROUND

### Field

The present disclosure relates to an automated transportation system.

### Related Art

For example, JP 2022-086198 discloses an automated transportation system for obtaining the position information and an identification information of an automated transportation device and an object to be conveyed to control the moving of the automated transportation device. In the automated transportation system, the recognizing marker which the worker installed in the predetermined position of the object to be conveyed is obtained images by the cameras arranged above the running path of the automated transportation device. The automated transportation system controls the movement and stop of the automated transportation device based on the acquired location information of the automated transportation device and the object to be conveyed, and identifies the object to be conveyed and the automated transportation device from the marker identification number obtained from the position recognition marker.

In the automated transportation system, a post-process may be handled in a way that requires higher positioning accuracy. Therefore, a technique capable of detecting the position of the automated transportation device and the object to be conveyed with high-precision is desired.

### SUMMARY

(1) According to one aspect of the present disclosure, an automated transportation system is provided. The automated transportation system includes an automated transportation device configured to transport an object to be conveyed, wherein the automated transportation device includes an identification code and a stop position confirmation marker attached to the automated transportation device, wherein the identification code indicates an identification information to identify at least either one of the object to be conveyed and the automated transportation device, a stereo camera configured to obtain an image of the identification code and the stop position confirmation marker, wherein the stereo camera is arranged at a predetermined stop position of the automated transportation device, an information processing device configured to obtain a three-dimensional stop position information of the automated transportation device and the identification information from the taken image, wherein the information processing device transmits the three-dimensional stop position information to a post-process equipment when the identification information is compatible with a predetermined condition. The post-process equipment is processing a post-process, wherein the post-process is later process than a conveyance process conveying the object to be conveyed by the automated transportation device.

According to the automated transportation system of this aspect, the three-dimensional stop position information can be acquired by using the stereo camera to detect a stop position confirmation marker arranged on the automated transportation device. Therefore, the position of the automated transportation device can be acquired with high accuracy.

### BRIEF DESCRIPTION OF THE DRAWINGS

FIG. 1 is an explanatory view showing the entire configuration of the automated transportation system according to a first embodiment of the present disclosure;

FIG. 2 is a block diagram showing the functional configuration of the automated transportation system; and

FIG. 3 is a flowchart showing the transport process of the automated transportation device performed by the automated transportation system.

### DETAILED DESCRIPTION

### A First Embodiment

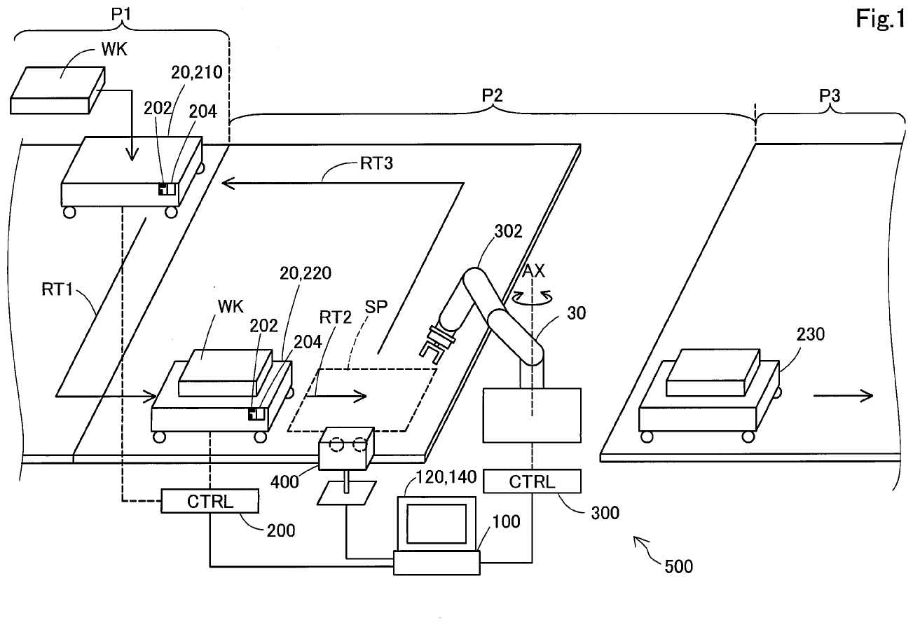

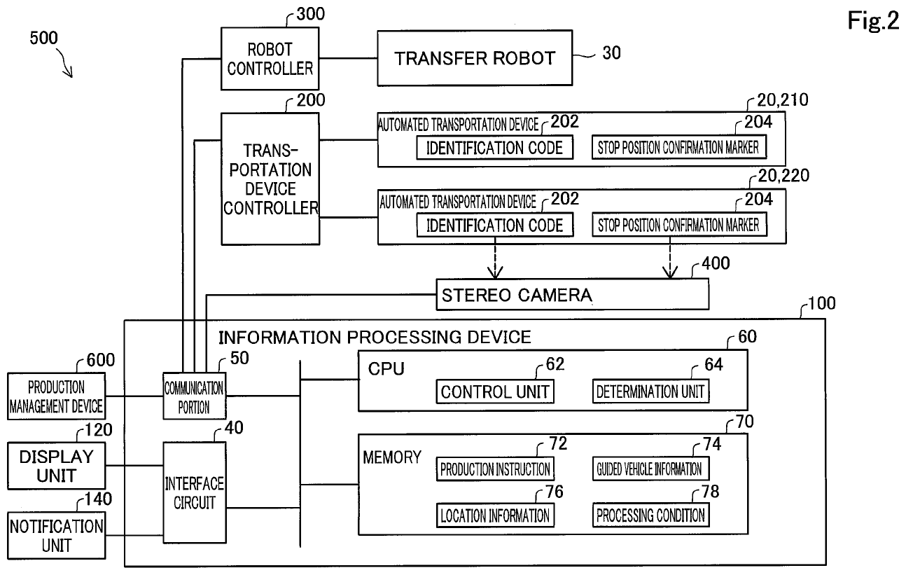

FIG. 1 is an explanatory view showing the whole composition of an automated transportation system 500 concerning the first embodiment of this disclosure. FIG. 2 is a block diagram showing the functional configuration of the automated transportation system 500. The automated transportation system 500 oversees, for example, a production-line that manufactures components for vehicles. In the illustration of FIG. 1, the production-line includes a subject process P2, a previous process P1 immediately before the subject process P2, and a next process P3 immediately after the subject process P2. The subject process P2 is a so-called material handling process. The subject process P2 passes the object to be conveyed WK processed by the previous process P1 to the next process P3. The object to be conveyed WK includes, for example, a vehicle, a vehicle component, and the like. The automated transportation system 500 controls the subject process P2 and controls several automated transportation device 20 and a transfer robot 30 that perform the subject process P2 tasks.

As shown in FIG. 1, the automated transportation system 500 includes a transportation device controller 200, a plurality of automated transportation device 20, a robot controller 300, the transfer robot 30, a stereo camera 400, and an information processing device 100. The transportation device controller 200 receives a control signal from the information processing device 100 and controls the automated transportation device 20 in response to the received control signal.

The automated transportation device 20 is the so-called AMR (Autonomous Mobile Robot). The automated transportation device 20 uses SLAM (Simultaneous Localization and Mapping) with LiDAR to perform self-position estimation, mapping, and automated driving. The automated transportation device 20 is equipped with the object to be conveyed WK and carries the loaded the object to be conveyed WK according to the instructions from the transportation device controller 200. In this embodiment, the object to be conveyed WK is placed at a predetermined location on the automated transportation device 20. The automated transportation device 20 may be an AGV (Automated Guided Vehicle with a fixed driving route).

In the embodiment of FIG. 1, the automated transportation device 20 includes a plurality of automated transportation device 210, 220 that orbit the previous process P1 and the subject process P2. Each the automated transportation device 210, 220 is assigned the identification information to identify the automated transportation device 20 individually. Control instructions are sent with the identification information of the automated transportation device 20. In the following explanation, when not distinguishing the automated transportation device 210, 220, collectively referred to as “the automated transportation device 20”.

In the present embodiment, the automated transportation device 20 travels according to a route traveled RT1, RT2, RT3 associated with the subject process P2 and the previous process P1. Upon receiving the travel instruction, the automated transportation device 20 drives the route traveled RT1, RT2, RT3 to a predetermined destination at a predetermined rate. For example, the automated transportation device 210 shown in FIG. 1 runs according to the route traveled RT1 and enters the subject process P2 when the object to be conveyed WK after treatment by the previous process P1 is mounted. The automated transportation device 220 shown in FIG. 1 runs according to the route traveled RT2 and is stopped at a predetermined the stop position SP adjoining the transfer robot 30. In the stop position SP, the transfer robot 30 handles the object to be conveyed WK on the automated transportation device 20. Once the object to be conveyed WK has been transported, the automated transportation device 220 will run according to the route traveled RT3 shown in FIG. 1 and return to the previous process P1.

When the robot controller 300 receives a control signal from the information processing device 100, it controls the transfer robot 30 in accordance with the received control instruction. The transfer robot 30 is an exemplary a post-process equipment. The post-process equipment is processing the post-process, wherein the post-process is later process than the conveyance process conveying the object to be conveyed WK by the automated transportation device 20. “processing” means performing certain tasks on the object to be conveyed WK, e.g. machining or conveyance. The post-process need not be a process immediately after the object to be conveyed WK is conveyed, and other processes may be included between the object to be conveyed WK conveyance and the post-process.

In the present embodiment, the transfer robot 30 performs the transportation of the object to be conveyed WK to the next process P3 as an exemplary process of the post-process. More specifically, the transfer robot 30 grasps the object to be conveyed WK on the automated transportation device 20 of the stop position SP under control by the robot controller 300. And the transfer robot 30 passes the object to be conveyed WK to the automated transportation device 230 of the next process P3. As will be described later, the transfer robot 30 refers to the three-dimensional co-ordinates of the automated transportation device 20 outputted from the information processing device 100 and controls a robot hand 302 to grasp the object to be conveyed WK on the automated transportation device 20. The transfer robot 30 rotates around the central axial AX with the object to be conveyed WK gripped, and releases and delivers the object to be conveyed WK to the automated transportation device 230 of the next process P3.

In the automated transportation device 20, the identification code 202 and the stop position confirmation marker 204 are arranged. The identification code 202 is a two-dimensional coding. The identification code 202 is associated with the automated transportation device 20 identification the identification information, such as ID, type, model number, and identification number of the automated transportation device 20. In the present embodiment, the identification code 202 is further associated with the automated transportation device 20 for identifying the object to be conveyed WK, such as ID, product name, type, model number, identification number, and serial number of the object to be conveyed WK, and the identification information. Incidentally, “the identification code 202 and a stop position confirmation marker 204 are arranged in the automated transportation device 20” includes a condition in which the identification code 202 and the stop position confirmation marker 204 are arranged on the object to be conveyed WK mounted on the automated transportation device 20.

The information included in the identification code 202 can be read from images capturing the identification code 202. The identification code 202 may use a variety of markers recognizable in the stereo camera 400, such as QR code (registered trademark), AR (Augmented Reality markers, another two-dimensional code, or a one-dimensional code such as a bar code. The identification code 202 may be associated with only one the identification information, either the automated transportation device 20 or the object to be conveyed WK.

The stop position confirmation marker 204 is a marker for the information processing device 100 to acquire the three-dimensional stop position information of the automated transportation device 20. The automated transportation device 20's the three-dimensional stop position information is, for example, the three-dimensional co-ordinate of the automated transportation device 20. In the present embodiment, the object to be conveyed WK is fixedly disposed at a predetermined position on the automated transportation device 20. Therefore, the stop position confirmation marker 204 can also be used to acquire three-dimensional co-ordinates of the object to be conveyed WK. The stop position confirmation marker 204 can be used various geometric shapes such as, for example, circular or polygonal. Various markers that can acquire three-dimensional coordinates by utilizing parallax due to the stereo camera 400 may be used for the stop position confirmation marker 204. In the present embodiment, the information processing device 100, from the captured images of the stop position confirmation marker 204, the relative position of the automated transportation device 20 with respect to the reference position to be stopped in the stop position SP, i.e. it is capable of obtaining a deviation from the reference position.

The stereo camera 400 acquires images of the identification code 202 and the stop position confirmation marker 204 of the automated transportation device 20. The identification code 202 and the stop position confirmation marker 204 are arranged close to each other. Therefore, the stereo camera 400 can acquire images of both the identification code 202 and the stop position confirmation marker 204 by a single imaging. The angle of view of the stereo camera 400 is preferably set widely in view of the variation of the stopping position at the stop position SP of the automated transportation device 20. The stereo camera 400 outputs the acquired images to the information processing device 100.

The information processing device 100 is a personal computer comprising a CPU 60 as a central processor, a memory 70, such as a ROM or RAM, a communication portion 50, and an interface circuit 40. The interface circuitry 40, a display unit 120 and a notification unit 140 are connected. The display unit 120 is a display that displays the conveyance status of the automated transportation device 20 and production-instruction-information, etc., according to the information processing device 100 process. The notification unit 140 is, for example, a Error indicator light, and notifies the user, manager, and workers, etc. that an error occurs in manufacturing.

The communication portion 50 is circuitry for performing radio communications between the transportation device controller 200, the robot controller 300, the stereo camera 400 and the production management device 600. The information processing device 100 transmits control signals to the transportation device controller 200 and the robot controller 300 by radio communication, acquires images from the stereo camera 400, and acquires production instructions from a production management device 600 that oversees production planning for the entire production line.

The CPU60 implements various functions provided in this embodiment, such as a control unit 62 and a determination unit 64, by executing a program stored in the memory 70. The control unit 62 controls a plurality of the automated transportation device 20 and the transfer robot 30. The determination unit 64 analyzes the images captured by the stereo camera 400 and judges anomalies in the subject process P2. The functions required for the information processing device 100 may be realized by any plurality of devices.

The read/write area of the memory 70 stores the data required for each part of the information processing device 100 to perform the processing. As shown in FIG. 2, the memory 70 includes a production instruction storage area 72, a guided vehicle information storage area 74, a location information storage area 76, and a processing condition storage area 78. The memory 70 may be comprised of an external storage device or database.

The production instruction storage area 72 stores the subject process P2 manufacturing instructions. Production instructions include, for example, the type of the subject process P2's the object to be conveyed WK, part number, the identification information, order of processing, date and time to be processed, processing requirements, and the identification information of the automated transportation device 20 on which the object to be conveyed WK is to be mounted. Production instructions may be received from the production management device 600 and may be entered by the user. The guided vehicle information storage area 74 stores the identification information of the automated transportation device 20 and the object to be conveyed WK mounted on the automated transportation device 20.

In the location information storage area 76, the three-dimensional coordinates of the automated transportation device 20 stopped by the stop position SP, and the three-dimensional coordinates of the object to be conveyed WK mounted on the automated transportation device 20 are stored. The location information storage area 76 may further store location information for each of the object to be conveyed WK and the automated transportation device 20 on the route traveled RT1, RT2, RT3 that is detected by a self-position sensor attached to the automated transportation device 20 or the object to be conveyed WK. As the self-position sensor can be used, for example, a GNSS (Global Navigation Satellite System (s)) and a gyrosensor or the like.

In the processing condition storage area 78, the conditions of the process by the post-process equipment are stored. In the present exemplary embodiment, the operational procedures of the robot hand 302 corresponding to each the identification information of the object to be conveyed WK is stored as the conditional on the process by the post-process equipment. The robot hand 302 operational procedures include, for example, the reference position of the object to be conveyed WK at the stop position SP by the three-dimensional coordinates, the grasping method by the robot hand 302, the position to grasp the object to be conveyed WK, etc.

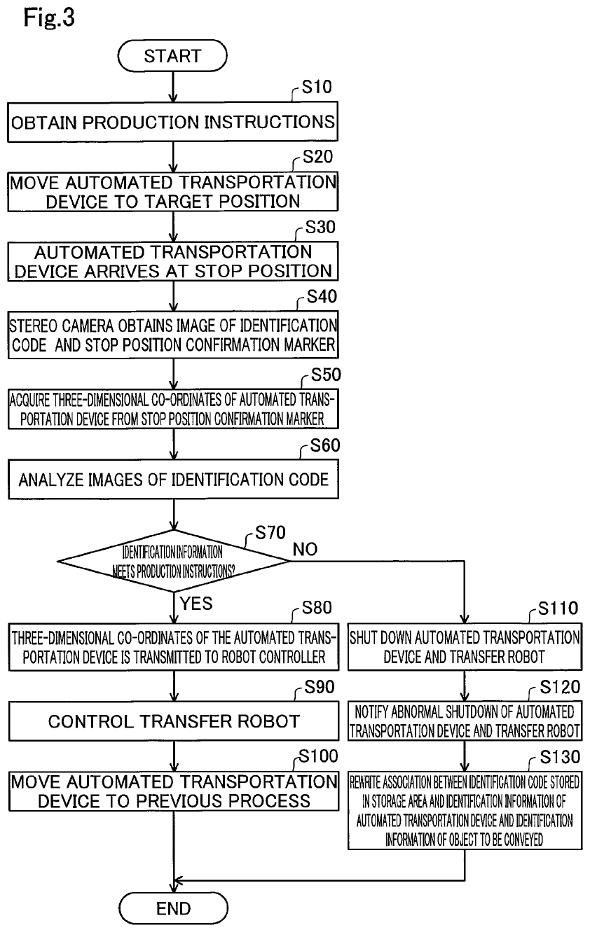

FIG. 3 is a flow chart showing the conveyance process of the automated transportation device 20 that the automated transportation system 500 executes. The process begins, for example, with the activation of the automated transportation system 500.

In step S10, the information processing device 100 obtains production instructions from the production management device 600. The control unit 62 acquires the identification information of the automated transportation device 20 to be controlled from the production instruction data. In step S20, the control unit 62 sends a control signal to the transportation device controller 200 to move the automated transportation device 20 with the identification information to be controlled to the stop position SP, which is the target position. The control unit 62 may, instead of the automated transportation device 20, acquire the object to be conveyed WK subject to the manufacturing instruction. In such cases, the control unit 62 acquires the automated transportation device 20 on which the target the object to be conveyed WK is mounted from the guided vehicle information storage area 74.

In step S30, the automated transportation device 20 arrives at the stop position SP by automated driving. The information processing device 100 acquires information what the automated transportation device 20 arrived at the stop position SP from the transportation device controller 200 or from the stereo camera 400 that detected the stop position confirmation marker 204. When the automated transportation device 20 to be arrived is not detected, an abnormality due to the notification unit 140 may be notified as the stopping position of the automated transportation device 20 is abnormal.

In step S40, the stereo camera 400 images the identification code 202 and the stop position confirmation marker 204 arranged in the automated transportation device 20 at once under the control of the control unit 62. The stereo camera 400 transmits images of the captured the identification code 202 and the stop position confirmation marker 204 to the information processing device 100.

In step S50, the determination unit 64 acquires three-dimensional co-ordinates of the automated transportation device 20 by analyzing the images of the stop position confirmation marker 204. More specifically, the determination unit 64 acquires an image captured by the stereo camera 400 and performs image analysis of the stop position confirmation marker 204 included in the acquired image. Examples of image analysis include, for example, SGM (Semi Global Matching) method and SAD (Sum of Absolute Difference) method. Consequently, the determination unit 64 acquires the relative three-dimensional co-ordinates of the automated transportation device 20 with respect to the reference position to be stopped at the stop position SP. The determination unit 64 stores the acquired three-dimensional coordinates in the location information storage area 76.

In step S60, the determination unit 64 analyzes the acquired images of the identification code 202. In step S70, the determination unit 64 verifies the automated transportation device 20's the identification information and the identification information obtained of the object to be conveyed WK by image-analysis with the production-instructions acquired in step S10. The determination unit 64 moves the process to the step S80 when the identification information meets the production instructions (S70: YES).

In step S80, the control unit 62 reads out the three-dimensional co-ordinates of the automated transportation device 20 acquired in the step S50 from the location information storage area 76 and transmits them to the robot controller 300. In step S90, the control unit 62 controls the transfer robot 30 pass the object to be conveyed WK to the next process P3 by transmitting a control signal to the robot controller 300. The robot controller 300 operates the robot hand 302 after adjusting the position of the object to be conveyed WK using the three-dimensional co-ordinates acquired from the control unit 62 In step S80. Thus, even if the variation occurs in the stopping position of the automated transportation device 20, the robot hand 302 can accurately grasp the object to be conveyed WK. When the transfer robot 30 passes the object to be conveyed WK to the next process P3's the automated transportation device 230, the robot controller 300 sends the information processing device 100 the resulting transport operation. In step S100, the control unit 62 sends control signaling to the transportation device controller 200 to move the automated transportation device 20 from the stop position SP to the previous process P1 to complete the process.

In step S70, when the information of the object to be conveyed WK is incompatible with the production instruction (S70:NO), the determination unit 64 proceeds to step S110 the process. In step S110, the control unit 62 sends control signaling to shut down the automated transportation device 20 and the transfer robot 30 to the transportation device controller 200 and the robot controller 300. In step S120, the determination unit 64 informs the notification unit 140 of an abnormal shutdown of the automated transportation device 20 and the transfer robot 30.

In step S130, by the determination unit 64 rewrites the association of the automated transportation device 20 stored in the guided vehicle information storage area 74 with the identification code 202 and the identification information of the automated transportation device 20 and the identification information of the object to be conveyed WK, the process of the automated transportation device 20 that is abnormally stalled is replaced with the process of the other automated transportation device 20. More specifically, by the determination unit 64 updates the data stored in the guided vehicle information storage area 74, the identification information of the object to be conveyed WK to be processed will be corresponded with the identification code 202 located in the other the automated transportation device 20 to be replaced. Thus, by a simple manner without changing the identification code 202, it is possible to replace the function of the automated transportation device 20 which is abnormally stopped to another the automated transportation device 20, it is possible to suppress or prevent the productivity is lowered. Incidentally, such as when there is not to replace the function in other the automated transportation device 20, S130 of steps may be omitted.

As described above, according to the automated transportation system 500 of the present embodiment, the object to be conveyed WK includes the automated transportation device 20 for acquiring an image of the automated transportation system 500 and the object to be conveyed WK, the identification code 202 and the stop position confirmation marker 204 indicating the identification information for identifying at least one of the object to be conveyed WK and the automated transportation device 20 are arranged in the automated transportation device 20, the automated transportation device 20 disposed on a predetermined stop position, and a predetermined stop position for acquiring the identification code 202 and the stop position confirmation marker 204 of the identification information from the acquired image and transmitting the automated transportation device 20 to a predetermined stop position for carrying out the automated transportation device 20 transportation process when the automated transportation device 20 conforms to a predetermined condition. By the stereo camera 400, the position of the automated transportation device 20 can be acquired with good accuracy by acquiring three-dimensional co-ordinates using the stop position confirmation marker 204 arranged in the automated transportation device 20. Further, the stereo camera 400, both the identification code 202 and the stop position confirmation marker 204 can be acquired by one detecting device, it is possible to suppress an increase in the number of components of the automated transportation system 500. By transmitting the three-dimensional co-ordinates acquired by the stereo camera 400 to the post-process's the transfer robot 30, calibration can be performed without providing position sensors in the automated transportation device 20 and the transfer robot 30.

According to the automated transportation system 500 of the present embodiment, the information processing device 100 performs error notification when the identification information indicated by the identification code 202 does not match the manufacturing instruction. Therefore, the user can respond early to the occurrence of abnormality.

According to the automated transportation system 500 of this embodiment, the information processing device 100 rewrites the correspondence between the identification code 202 and the identification information without changing the identification code 202. This makes it possible to substitute the function of the automated transportation device 20 to another the automated transportation device 20 by a simple way without changing the identification code 202 arranged in the automated transportation device 20.

According to the automated transportation system 500 of this embodiment, the post-process equipment is the transfer robot 30 comprising the robot hand 302 for grasping the object to be conveyed WK according to the transmitted three-dimensional stopping position. Since it is possible to execute the position adjustment using the three-dimensional position acquired by the stereo camera 400, it is possible to improve the alignment accuracy of the transfer robot 30 without newly providing a sensor such as a camera on the transfer robot 30.

### B. Other Embodiments

(B1) In the above-described embodiment, the determination unit 64 replaces the function of the other the automated transportation device 20 by rewriting the correspondence between the identification code 202 and the identification information of the automated transportation device 20 and the object to be conveyed WK. On the other hand, for example, the automated transportation device 20 of the identification code 202, such as being rewritten in the same the automated transportation device 20 as the identification code 202 of the original the identification code, by rewriting the identification code, the identification code, the identification information of the automated transportation device 20 and the correspondence with the object to be conveyed WK may be rewritten. A simple way to rewrite the identification code is to maintain the association between the identification code 202 and the automated transportation device 20's the identification information and the object to be conveyed WK's the identification information. Rewriting of the identification code, for example, using the identification code 202 of the liquid crystal display, can be rewritten by switching the display of the identification code 202. The rewriting of the identification code may be rewritten by attaching the identification code 202 after the change to the identification code 202 prior to the change. Differential the identification code 202 may also be rewritten by changing the temperature of the identification code 202 by using the identification code 202 with a temperature indicator containing a leuco dye and a developer.

The present disclosure is not limited to the embodiments described above and is able to be realized with various configurations without departing from the spirit thereof. For example, technical features in the embodiments are able to be replaced with each other or combined together as necessary in order to solve part or the whole of the problems described previously or to achieve part or the whole of the effects described previously. When the technical features are not described as essential features in the present specification, they are able to be deleted as necessary. For example, the present disclosure may be realized with embodiments which will be described below.

(1) According to one aspect of the present disclosure, an automated transportation system is provided. The automated transportation system includes an automated transportation device configured to transport an object to be conveyed, wherein the automated transportation device includes an identification code and a stop position confirmation marker attached to the automated transportation device, wherein the identification code indicates an identification information to identify at least either one of the object to be conveyed and the automated transportation device, a stereo camera configured to obtain an image of the identification code and the stop position confirmation marker, wherein the stereo camera is arranged at a predetermined stop position of the auto mated transportation device, an information processing device configured to obtain a three-dimensional stop position information of the automated transportation device and the identification information from the taken image, wherein the information processing device transmits the three-dimensional stop position information to a post-process equipment when the identification information is compatible with a predetermined condition. The post-process equipment is processing a post-process, wherein the post-process is later process than a conveyance process conveying the object to be conveyed by the automated transportation device.
According to the automated transportation system of this aspect, the three-dimensional stop position information can be acquired by using the stereo camera to detect a stop position confirmation marker arranged on the automated transportation device. Therefore, the position of the automated transportation device can be acquired with high accuracy.
(2) In the automated transportation system of the above-described aspect, the information processing device may perform abnormality notification when the identification information incompatible with the predetermined condition.
According to the automated transportation system of this aspect, the user can respond early to the generation of the abnormality by the notification.
(3) In the automated transportation system of the above-described aspect, the identification code may be configured to be changeable.
According to the automated transportation system of this aspect, the correspondence between at least one of the identification information of the automated transportation device and the identification information of the object to be conveyed and the identification code can be updated by a simple way of changing an identification code.
(4) In the automated transportation system of the above-described aspect, the information processing device may rewrite a correspondence relationship between the identification code and the identification information without changing the identification code.
According to the automated transportation system of this aspect, the function of transporting the object to be conveyed subject to the identification code can be transferred to another the automated transportation device by a simple way without changing the identification code.
(5) In the automated transportation system of the above-described aspect, the post-process equipment may be a robot that grasps the object to be conveyed according to the transmitted three-dimensional stop position information.
According to the automated transportation system of this aspect, the robots can execute the position adjustment using the three-dimensional stop position information acquired by the stereo camera. Therefore, without newly providing a sensor such as a camera to the robot, it is possible to improve the alignment accuracy of the robot.
The present disclosure is feasible in various aspects other than the automated transportation system. For example, the present disclosure may be realized in aspects including an automated transportation device, a transport method, an automated transportation device control method, an automated transportation system control method, a computer program that implements the control method, or a non-temporary recording medium on which the computer program is recorded.

What is claimed is:

1. An automated transportation system comprising:
an automated transportation device configured to transport an object to be conveyed, wherein the automated transportation device includes an identification code and a stop position confirmation marker attached to the automated transportation device, wherein the identification code indicates an identification information to identify at least either one of the object to be conveyed and the automated transportation device;
a stereo camera configured to obtain an image of the identification code and the stop position confirmation marker, where in the stereo camera is arranged at a predetermined stop position of the automated transportation device;
an information processing device configured to obtain a three-dimensional stop position information of the automated transportation device and the identification information from the taken image, wherein the information processing device transmits the three-dimensional stop position information to a post-process equipment when the identification information is compatible with a predetermined condition,
wherein the post-process equipment is processing a post-process, wherein the post-process is later process than a conveyance process conveying the object to be conveyed by the auto mated transportation device.

2. The automated transportation system according to claim 1, wherein the information processing device performs abnormality notification when the identification information incompatible with the predetermined condition.

3. The automated transportation system according to claim 1, wherein the identification code is configured to be changeable.

4. The automated transportation system according to claim 1, wherein the information processing device rewrites a correspondence relationship between the identification code and the identification information without changing the identification code.

5. The automated transportation system according to claim 1, wherein the post-process equipment is a robot that grasps the object to be conveyed according to the transmitted three-dimensional stop position information.
